(19) United States
(12) Patent Application Publication
(10) Pub. No.: US 2010/0306466 A1
(43) Pub. Date: Dec. 2, 2010

(54) METHOD FOR IMPROVING DISK AVAILABILITY AND DISK ARRAY CONTROLLER

(75) Inventor: Xiao LI, Beijing (CN)

Correspondence Address: LADAS & PARRY LLP, 224 SOUTH MICHIGAN AVENUE, SUITE 1600, CHICAGO, IL, 60604, US

(73) Assignee: HANGZHOU H3C TECHNOLOGIES CO., LTD., Hangzhou City (CN)

(21) Appl. No.: 12/787,648

(22) Filed: May 26, 2010

(30) Foreign Application Priority Data
May 27, 2009 (CN) 200910085737.7

(51) Int. Cl. G06F 12/00; G06F 12/16

(52) U.S. Cl. 711/114; 711/162; 711/E12.001; 711/E12.103

(57) ABSTRACT

The present invention discloses a method for improving disk availability and a disk array controller. The method includes: determining, when detecting that part of tracks of a disk in a disk array is damaged, a first master data storage space in a damaged track; selecting an idle first backup data storage space from at least one back data storage space, establishing a corresponding relation between an address of a strip contained in the first master data storage space and an address of a strip contained in the first backup data storage space; and receiving an instruction for accessing the strip contained in the first master data storage space, finding the strip contained in the first backup data storage space according to an address of the strip in the instruction and the corresponding relation, and accessing the strip contained in the first backup data storage space.

### FIELD OF THE INVENTION

The present invention relates to network communication technologies, more particularly, to a method for improving disk availability and a disk array controller.

### BACKGROUND OF THE INVENTION

At present, in order to improve the storage performance and data security of a disk, a Redundant Array of Independent Disks (RAID) comes forth, called a disk array for short. The disk array technology refers to forming an array by combining multiple disks, selectively distributing data into multiple disks of the array, and increasing bandwidth and increasing access speed through the parallel access and parallel transmission of the multiple disks. For a host, the disk array is similar to a rapid and large-capacity disk, and can improve the availability and storage capacity of network data.

In the disk array, data are organized in an extent mode, a strip mode or a stripe mode. FIG. 1 is a schematic diagram illustrating an extent structure of the disk array. FIG. 2 is a schematic diagram illustrating strip and stripe structures of the disk array. Referring to FIG. 1, in the disk array, each disk is divided into at least one extent. Referring to FIG. 2, each extent is divided into multiple strips after each disk in the disk array is divided into at least one extent, and strips which are in different extents of the disk array and are associated in locations, e.g. each first strip in the at least one extent, are aggregated to form a stripe. In other words, the strip is an element of the stripe and is the smallest unit for storing data in the disk array.

In practical applications, it usually happens that a physical track of a disk in the disk array is damaged. Conventionally, this case is processed through: once a damaged physical track of a disk is detected, whether part or all of tracks of the disk are damaged, the whole disk is deemed as unavailable and the disk is replaced with a new disk.

However, in practical applications, not all tracks of a disk are damaged in many circumstances, but just part of tracks is damaged. Conventionally, when just part of tracks is damaged, the whole disk is deemed as unavailable and the disk is replaced with a new disk. As a result, the disk availability in the disk array is greatly decreased and disk resources are greatly wasted.

Further, for a disk array with a fault-tolerant mechanism, if just part of tracks of a disk is damaged and the rest of tracks are normal, data in a stripe containing normal tracks can be read correctly. However, because the disk is replaced with a new disk conventionally, data in all tracks of the replaced disk need be reconstructed. In other words, not only the data in the stripe containing the damaged tracks need be reconstructed, but also the data which are in the stripe containing the normal tracks and can be read correctly need be reconstructed, which requires a long period for data reconstruction and occupies a mass of processing capacity.

Further, because of the long period for data reconstruction, a track of another disk may be damaged during the time period for data reconstruction. Thereby, it is easy to exceed the number of unavailable disks which the disk array can support, which may cause the whole disk array unavailable and make all data in the disk array lost.

### SUMMARY OF THE INVENTION

In view of the above, the present invention provides a method for improving disk availability and a disk array controller, which can improve the disk availability in a disk array.

The technical scheme of the present invention can be implemented as follows.

A method for improving disk availability includes: accessing a strip contained in a master data storage space set in a disk array when a track in which the master data storage space is located is normal; determining, when detecting that part of tracks of a disk in the disk array is damaged, a first master data storage space in a damaged track; selecting an idle first backup data storage space from at least one backup data storage space, establishing a corresponding relation between an address of a strip contained in the first master data storage space and an address of a strip contained in the first backup data storage space; and receiving an instruction for accessing the strip contained in the first master data storage space, finding the strip contained in the first backup data storage space according to an address of the strip in the instruction and the corresponding relation, and accessing the strip contained in the first backup data storage space.

A disk array controller includes:
a disk space setting module, adapted to set at least one backup data storage space and set a master data storage space in a disk array;
an abnormity processing module, adapted to determine, when detecting that part of tracks of a disk in the disk array is damaged, a first master data storage space located in a damaged track, select an idle first backup data storage space, and store a corresponding relation between an address of a strip contained in the first master data storage space and an address of a strip contained in the first backup data storage space; and
an access processing module, adapted to find, when receiving an instruction for accessing the strip contained in the first master data storage space, the strip contained in the first backup data storage space according to an address of the strip in the instruction and the corresponding relation; and access the strip contained in the first backup data storage space.

A method for enhancing availability of a Redundant Array of Independent Disks (RAID), wherein the RAID is constructed with N disks comprising a plurality of strips, in which a plurality of stripes are constructed and each stripe comprises N strips respectively from N disks, wherein at least one strip acts as a parity strip in a stripe, the method includes:
calculating the data in a master strip which belongs to a stripe according to the left strips in the stripe in response to a failure event of the master strip;
writing the calculated data into a backup strip which is located in the same disk for replacing the master strip;
mapping a logical address included in an access instruction of a host into a physical address of a backup strip after the writing.

As can be seen, in the present invention, when part of tracks of a disk in the disk array is damaged, the whole disk is not regarded as unavailable and is not replaced with a new disk; instead, the master data storage space affected by the damaged track is determined and then the access to the strip contained in the master data storage space is switched to the selected backup data storage space. That is, the master data storage space affected by the track damage is replaced with the preset backup data storage space, so that it is not necessary to replace the disk and the disk availability is improved.

Further, for the disk array with a fault-tolerant mechanism, it is unnecessary to reconstruct the data in the whole disk, but only the data in the strip contained in the data storage space in the damaged track need be reconstructed, thereby decreasing the time period for data reconstruction and the occupation of the system processing resources.

Further, because the time period for data reconstruction becomes shorter, the circumstances that a track of another disk is damaged during the time period for data reconstruction are much less and the circumstances of exceeding the number of unavailable disks which the disk array can support are also much less, which avoids the loss of all data in the whole disk array when the whole disk array is unavailable and thereby improves the performance of the disk array greatly.

### BRIEF DESCRIPTION OF THE DRAWINGS

FIG. 1 is a schematic diagram illustrating an extent structure in a disk array.

FIG. 2 is a schematic diagram illustrating strip and stripe structures in a disk array.

FIG. 3 is a flowchart according to a first embodiment of the present invention.

FIG. 4a is a schematic diagram illustrating a first mode of data storage and backup in a disk array of the first embodiment.

FIG. 4b is a schematic diagram illustrating a second mode of data storage and backup in a disk array of the first embodiment.

FIG. 5 is a flowchart according to a second embodiment of the present invention.

FIG. 6a is a schematic diagram illustrating a first mode of data storage and backup in a disk array of the second embodiment.

FIG. 6b is a schematic diagram illustrating a second mode of data storage and backup in a disk array of the second embodiment.

FIG. 7 is a schematic diagram illustrating a basic structure of a disk array controller according to an embodiment of the present invention.

### DETAILED DESCRIPTION OF THE INVENTION

In order to make the object, the technical scheme and merits of the present invention clearer, the present invention will be described hereinafter in detail with reference to accompanying drawings and embodiments.

The present invention provides a method for improving disk availability, including: setting a master data storage space in a disk array, and accessing a strip contained in the master data storage space when a track in which the master data storage space is located is normal; setting at least one backup data storage space; when detecting that part of tracks of a disk in the disk array is damaged, determining a first master data storage space on a damaged track; selecting an idle first backup data storage space, establishing a corresponding relation between an address of a strip contained in the first master data storage space and an address of a strip contained in the first backup data storage space; when receiving an instruction for accessing the strip contained in the first master data storage space, finding the strip contained in the first backup data storage space according to the corresponding relation and an address of the strip indicated in the instruction, and accessing the strip contained in the first backup data storage space.

As can be seen, in the present invention, when part of tracks of a disk in the disk array is damaged, the whole disk is not deemed as unavailable and is not replaced with a new disk. Instead, a master data storage space affected by track damage is determined, and the access to the strip contained in the master data storage space determined is switched to a backup data storage space selected. In other words, the master data storage space affected by the track damage is replaced with a preset backup data storage space, so that the disk need not be replaced and the disk availability is thereby improved.

At present, in the disk array, data are usually organized and stored in a strip and a stripe in an extent. The strip is an element of the stripe and is the smallest unit of data storage. Therefore, a strip or a stripe can be taken as the data storage space mentioned in the above method of the present invention. In this way, after part of tracks of the disk is damaged, a stripe may be taken as a backup object, and a master stripe affected by the track damage is replaced with the backup object; or, after part of tracks of the disk is damaged, a strip may be taken as a backup object, and a master strip affected by the damaged tracks is replaced with the backup object.

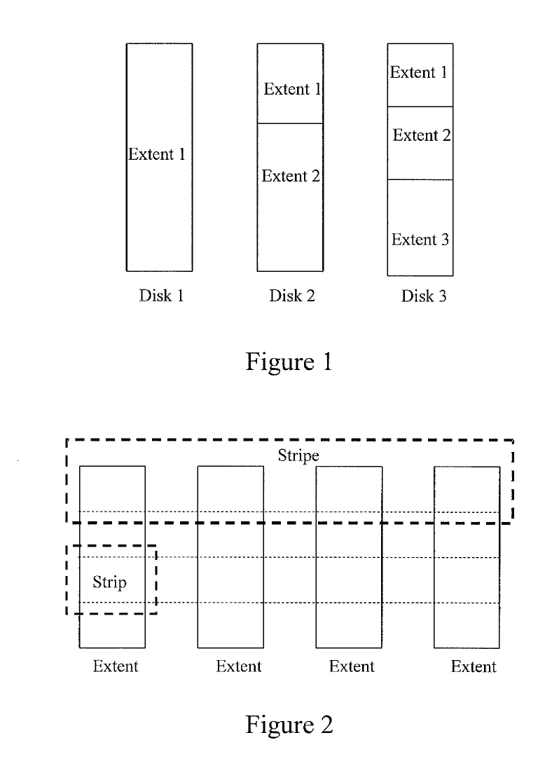

Certainly, taking the strip or the stripe as the data storage space mentioned in the method of the present invention, i.e. taking the strip or the stripe as a backup object, is just a preferred embodiment of the present invention. In practical applications, other feasible data storage spaces may be adopted according to the method provided by the present invention. For example, referring to FIG. 2, a space consisting of a strip affected by the track damage and two strips located respectively at the upper and the lower of the strip in the disk is taken as the data storage space mentioned in the method of the present invention.

The implementation of the method provided by the present invention will be described in detail hereinafter with reference to two embodiments.

### First Embodiment

In the first embodiment, a stripe is taken as the data storage space mentioned by the present invention, i.e. a backup object, and a master stripe affected by the track damage is replaced with a backup stripe, so as to improve the disk availability.

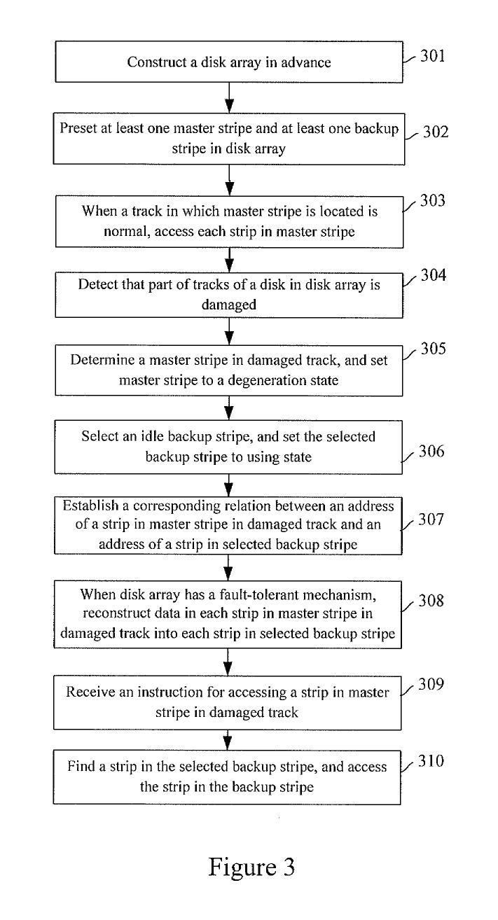

FIG. 3 is a flowchart according to the first embodiment. Referring to FIG. 3, in the first embodiment, the implementation procedure of improving the disk availability includes the following steps.

Step 301: A disk array is constructed in advance.

Step 302: At least one master stripe is preset in the disk array, and at least one backup stripe is preset.

Step 302 may be performed when a logical volume of the disk array is set. Setting a stripe is a conventional technology and will not be described here.

It should be noted that, according to characteristics of practical services, the above two steps may be implemented in the following two modes.

First Mode:

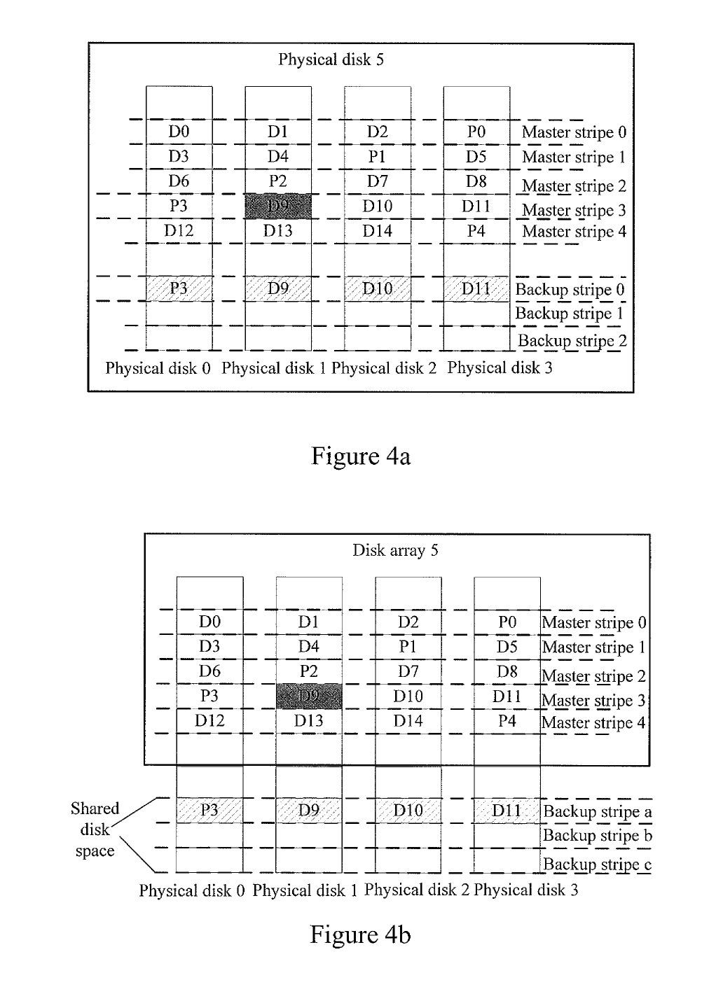

Referring to FIG. 4a, the first mode is to allow each disk array to have a dedicated backup stripe. The specific implementation procedure includes: first, the disk array is created according to the size of a practically-needed storage space of the disk array and the size of a storage space of the preset backup stripe; second, at least one backup stripe is set in the disk array.

For example, if the size of the practically-needed storage space of a disk array 5 is 100 G and the size of the storage space of the dedicated backup stripe of the disk array 5 is 10 G, the disk array 5 of 110 G is first created. Second, the dedicated backup stripe can be set inside the disk array 5.

Second Mode:

Referring to FIG. 4b, the second mode is to allow multiple disk arrays to share a backup stripe. The specific implementation procedure includes: first, the disk array is created according to the size of the needed storage space of the disk array; second, a disk space shared by multiple disk arrays including the created disk array is demarcated, and at least one backup stripe is set in the shared disk space.

For example, if the size of the practically-needed storage space of the disk array 5 is 100 G, the disk array 5 of 100 G is created first. Second, the disk space shared by multiple disk arrays including the disk array 5 is demarcated, e.g. the disk space of 50 G, and at least one backup stripe is set in the shared disk space of 50 G. In this way, the disk array 5 shares the backup stripe with the other disk arrays.

Step 303: When a track in which the master stripe is located is normal, each strip in the master stripe is accessed, i.e. read and write data of each strip in the master stripe.

Step 304: It is detected that part of tracks of a disk in the disk array is damaged.

The implementation procedure of this step is a conventional technology and may be described in a simple example as follows: detecting whether part of tracks of the disk is damaged according to whether a read-write operation on the disk succeeds in part of tracks of the disk while fails in the other part of tracks; or, detecting by a driving program that part of tracks of the disk is damaged.

Step 305: A master stripe in a damaged track is determined and is set in a degraded state.

In this step, the master stripe in the damaged track is determined according to an address of the damaged track of the disk and an address of each master stripe in the disk. For example, the master stripe in the damaged track is stripe 3 shown in FIGS. 4a and 4b.

Step 306: An idle backup stripe is selected, and the selected backup stripe is set in a use state.

If Steps 301 and 302 are implemented in the first mode, in this step, the idle backup stripe is selected from the inside of the disk array. For example, referring to FIG. 4a, an idle backup stripe 0 in the inside of the disk array 5 is selected.

If Steps 301 and 302 are implemented in the second mode, in this step, an idle backup stripe is selected from the shared disk space independent of the disk array. For example, referring to FIG. 4b, an idle backup stripe a in the inside of the disk space shared by the disk array 5 and other disk arrays is selected.

Step 307: A corresponding relation is established between an address of each strip in the master stripe in the damaged track and an address of each strip in the selected backup stripe.

Each strip in the master stripe has a logical address and a physical address. The logical address is an address used for a user's access. The backup stripe is transparent for the user. Thus, the strip in the backup stripe need not be allocated with a logical address, and only be allocated with a physical address. In this way, in this step, the corresponding relation can be established in the following two modes.

The mode A: the corresponding relation is established between a logical address of each strip in the master stripe in the damaged track and a physical address of each strip in the selected backup stripe.

The mode B: the corresponding relation is established between a physical address of each strip in the master stripe in the damaged track and the physical address of each strip in the selected backup stripe.

Step 308: When the disk array has a fault-tolerant mechanism, data in each strip in the master stripe in the damaged track are reconstructed into each strip in the selected backup stripe.

The disk array may be a disk array with a fault-tolerant mechanism or a disk array without a fault-tolerant mechanism. The fault-tolerant mechanism refers to that data in each stripe in the disk array have backup data or a check value, and that, when data in some strips in a stripe is unavailable, the unavailable data in the strips can be recovered by using the backup data in the other strips or by using the data and check value in the other strips in the stripe.

Conventionally, for the disk array with a fault-tolerant mechanism, the unavailable data in the strip are recovered by using the backup data in the other strips or by using the data and check value in the other strips in the stripe after the disk is replaced with the new disk, and data in all strips in the replaced disk are copied into the new disk. In the present invention, for the disk array with the fault-tolerant mechanism, e.g. Raid1, Raid3, Raid5, Raid6, Raid10, Raid01 and Raid50 levels, only data in each strip in the master stripe in the damaged track are reconstructed into each strip in the selected backup stripe. For example, referring to FIGS. 4a and 4b (where, FIG. 4a corresponds to a circumstance that Steps 301 and 302 adopt the first mode and FIG. 4b corresponds to a circumstance that Steps 301 and 302 adopt the second mode), in Step 308, the data in each strip in the master stripe 3 in the damaged track are reconstructed into each strip in the selected backup stripe 0 or the backup stripe a. The reconstruction is the same as the prior art, e.g., if part of tracks in which a D9 strip in the master stripe 3 is located is damaged, data in the D9 strip is recovered during the reconstruction by using the other strips and a check value P3 in the master stripe 3, and data in all strips in the master stripe 3 is copied into all strips in the backup stripe 0 or the backup stripe a.

It should be described that, if the disk array has no fault-tolerant mechanism, e.g. for a Raid0 level, Step 308 need not be performed.

Step 309: An instruction for accessing a strip in the master stripe on the damaged track is received, and the instruction contains a logical address of the strip.

Step 310: A strip in the selected backup stripe is found according to the logical address of the strip in the instruction and the corresponding relation established in Step 307, and the strip in the backup stripe is accessed.

If the corresponding relation is established in the mode A in Step 307, in Step 310, a physical address of the strip in the selected backup stripe is found in the established corresponding relation according to the logical address of the strip in the instruction, so as to access each strip in the backup stripe.

If the corresponding relation is established in the mode B in Step 307, in Step 310, the logical address of the strip in the instruction is converted into a physical address of the strip, and then the physical address of the strip in the selected backup stripe is found from the established corresponding relation according to the physical address of the strip in the instruction, so as to access each strip in the backup stripe.

For example, referring to FIG. 4a, the instruction indicates that data in the D9 and D10 strips in the stripe 3 need be accessed, but damage of a track in which the stripe 3 is located makes the data in the D9 strip are unavailable. And thus, through Step 310, the D9 and D10 strips in the backup stripe 0 are found, and the data in the D9 and D10 strips are accessed.

As can be seen, for the disk array with a fault-tolerant mechanism, the data in each strip in the master stripe in the damaged track are reconstructed into each strip in the backup stripe, while the original data still exist in each strip in the master stripe. Therefore, the historical data can still be accessed. Certainly, in subsequent procedures, the historical data in each strip in the backup stripe can be updated so that new data can also be accessed. However, for a disk array without a fault-tolerant mechanism, because data can not be reconstructed, the historical data in each strip in the master stripe in the damaged track is lost. In this case, the subsequent data access is performed by replacing each strip in the master stripe in the damaged track with each strip of the backup stripe.

In the flowchart shown in FIG. 3, in order to improve the disk availability, when a track in which the first selected backup stripe is located is also damaged, another idle backup stripe is selected again. For example, referring to FIG. 4a, when a track in which the first selected backup stripe 0 is located is damaged, a backup stripe 1 is selected again. The established corresponding relation between the address of each strip in the master stripe 3 and the address of each strip in the backup stripe 0 is updated into a corresponding relation between the address of each strip in the master stripe 3 and an address of each strip in the backup stripe 1. When the disk array has a fault-tolerant mechanism, the data in each strip in the backup stripe 0 are reconstructed into each strip in the backup stripe 1. Subsequently, when the instruction for accessing the strip in the master stripe 3 is received, the strip in the backup stripe 1 is found according to the address of the strip in the instruction and the updated corresponding relation, and the strip in the backup stripe 1 is accessed.

### Second Embodiment

In the second embodiment, a strip is taken as the data storage space mentioned by the present invention, i.e. a backup object, and the master strip affected by the track damage is replaced with a backup strip so as to improve the disk availability.

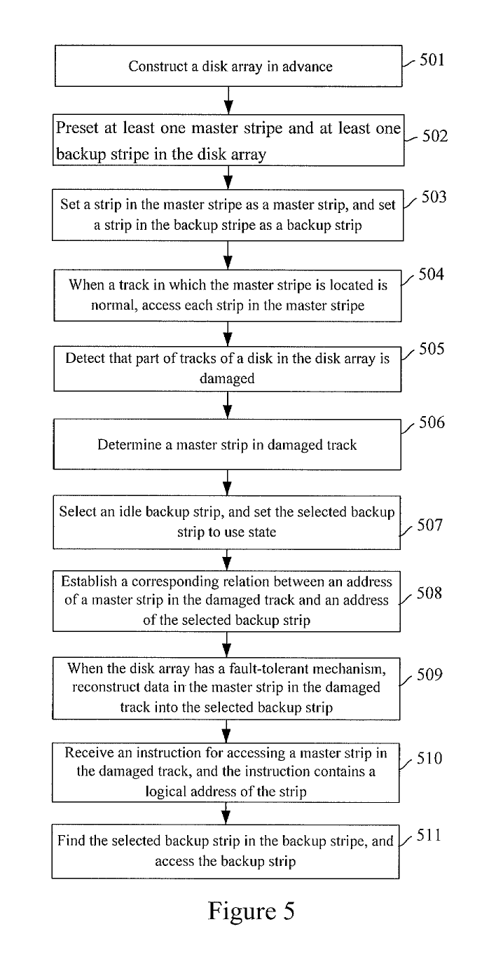

FIG. 5 is a flowchart according to the second embodiment. Referring to FIG. 5, in the second embodiment, the implementation procedure of improving the disk availability includes the following steps.

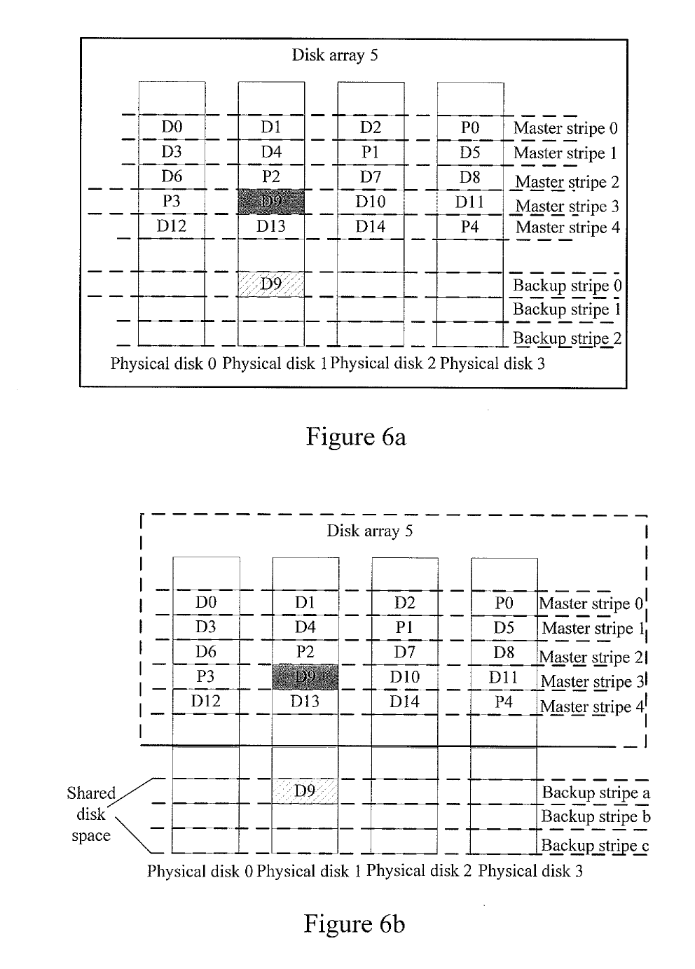

The description of Steps 501 and 502 is the same as the description of Steps 301 and 302, FIG. 4a need be replaced with FIG. 6a and FIG. 4b need be replaced with FIG. 6b.

Step 503: A strip in the master stripe is set as a master strip, and a strip in the backup stripe is set as a backup strip.

The description of Steps 504 and 505 is the same as the description of Steps 303 and 304.

Step 506: A master strip in a damaged track is determined.

In this step, the master strip in the damaged track is determined through the address of the damaged track of the disk and the address of each strip in each master stripe. For example, the master strip in the damaged track is the D9 strip in the stripe 3 shown in FIGS. 6a and 6b.

Step 507: An idle backup strip is selected, and the selected backup strip is set in a use state.

If the above Steps 501 and 502 are implemented in the first mode, in this step, the idle backup strip in the backup stripe is selected from the inside of the disk array. For example, referring to FIG. 6a, an idle backup strip in the backup stripe 0 is selected from the inside of the disk array 5.

If the above Steps 501 and 502 are implemented in the second mode, in this step, the idle backup strip in the backup stripe is selected from the shared disk space independent of the disk array. For example, referring to FIG. 6b, an idle backup strip in the backup stripe a is selected from the inside of the disk space shared between the disk array 5 and other disk arrays.

Step 508: A corresponding relation between an address of the master strip in the damaged track and an address of the selected backup strip.

In this step, the corresponding relation may be established in the following two modes.

Mode A′: A corresponding relation is established between a logical address of the master strip in the damaged track and a physical address of the selected backup strip.

Mode B′: A corresponding relation is established between a physical address of the master strip in the damaged track and a physical address of the selected backup strip.

Step 509: When the disk array has a fault-tolerant mechanism, the data in the master strip in the damaged track is reconstructed into the selected backup strip.

For the disk array with a fault-tolerant mechanism, e.g. Raid1, Raid3, Raid5, Raid6, Raid10, Raid01 and Raid50 levels, referring to FIG. 6a or 6b (FIG. 6a corresponds to the case that Steps 501 and 502 adopt the first mode and FIG. 6b corresponds to the case that Steps 501 and 502 adopt the second mode), in Step 509, only the data in the master strip D9 in the damaged track are reconstructed into the selected strip in the backup stripe 0 or in the backup stripe a. The specific reconstruction idea is the same as that in the prior art, e.g. the data in the D9 strip is recovered through other strips and a check value P3 in the master stripe 3, and the recovered data in the D9 strip is copied into the strip selected from the backup stripe 0 or from the backup stripe a.

It should be described that, if the disk array has no fault-tolerant mechanism, e.g. for the Raid0 level, this step need not be performed.

Step 510: An instruction for accessing a master strip in the damaged track is received, and the instruction contains a logical address of the strip.

Step 511: The backup strip selected from the backup stripe is found according to the logical address of the strip in the instruction and the established corresponding relation, and the backup strip is accessed.

If the corresponding relation is established in the mode A′ in Step 508, in this step, the physical address of the selected backup strip is found in the established corresponding relation according to the logical address of the strip in the instruction, so as to access the backup strip.

If the corresponding relation is established in the mode B′ in Step 508, in this step, the logical address of the strip in the instruction is converted into a physical address of the strip, and then the physical address of the strip in the selected backup stripe is found in the established corresponding relation according to the physical address of the strip in the instruction, so as to access each strip in the backup stripe.

For example, referring to FIG. 6a, the instruction indicates that the D9 strip in the stripe 3 need be accessed, while the data in the D9 strip is unavailable. And thus, by this step, the D9 strip in the backup stripe 0 is found, and the data in the D9 strip are accessed.

In the flowchart shown in FIG. 5, in order to further improve the disk availability, when a track in which the first selected backup strip is located is also damaged, another idle backup strip is selected again. For example, referring to FIG. 6a, when a track in which the backup strip in the first selected backup stripe 0 is located is damaged, the backup strip in the backup stripe 1 is selected again. The established corresponding relation between the address of the D9 strip in the master stripe 3 and the address of the D9 strip in the backup stripe 0 is updated into a corresponding relation between the address of the D9 strip in the master stripe 3 and the address of the D9 strip in the backup stripe 1. When the disk array has a fault-tolerant mechanism, the data in the D9 strip in the backup stripe 0 are reconstructed in the D9 strip of the backup stripe 1. Subsequently, when the instruction for accessing the D9 strip in the master stripe 3 is received, the D9 strip in the backup stripe 1 is found according to the address of the strip in the instruction and the updated corresponding relation, and the D9 strip in the backup stripe 1 is accessed.

In the method of the present invention, each step can be performed by a disk array controller which can control the access to the disk array.

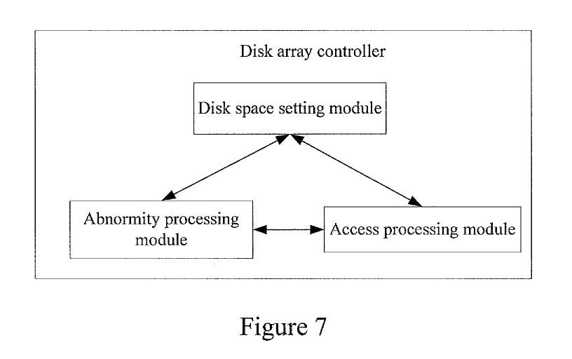

In addition, the present invention provides a disk array controller. Referring to FIG. 7, the disk array controller includes:
a disk space setting module, adapted to set at least one backup data storage space and set a master data storage space in a disk array;
an abnormity processing module, adapted to determine, when detecting that part of tracks of a disk in the disk array is damaged, a first master data storage space located in a damaged track, select an idle first backup data storage space, and store a corresponding relation between an address of a strip contained in the first master data storage space and an address of a strip contained in the first backup data storage space; and
an access processing module, adapted to find, when receiving an instruction for accessing the strip contained in the first master data storage space, the strip contained in the first backup data storage space according to the corresponding relation stored in the abnormity processing module and an address of the strip in the instruction, and accessing the strip contained in the first backup data storage space.

The disk space setting module is further adapted to construct the disk array according to the size of required storage space of the disk array and the size of the preset backup data storage space, and then setting at least one backup data storage space in the disk array; or
the disk space setting module is further adapted to construct the disk array according to the size of required storage space of the disk array, demarcate a disk space shared by multiple disk arrays including this disk array, and then setting at least one backup data storage space in the shared disk space.

When the disk array has a fault-tolerant mechanism,
the abnormity processing module is further adapted to reconstruct data in the strip contained in the first master data storage space into the strip contained in the first backup data storage space;
the abnormity processing module is further adapted to select, when a track in which the first backup data storage space is located is damaged, an idle second backup data storage space; update the stored corresponding relation into a corresponding relation between the address of the strip contained in the first master data storage space and an address of a strip contained in the second backup data storage space; if the disk array has a fault-tolerant mechanism, reconstruct data in the strip contained in the first master data storage space into the strip contained in the second backup data storage space;
the access processing module is further adapted to receive the instruction for accessing the strip contained in the first master data storage space, find the strip contained in the second backup data storage space according to the address of the strip in the instruction and the updated corresponding relation, and access the strip contained in the second backup data storage space.

Preferably, the disk space setting module is adapted to set the at least one backup data storage space through taking a stripe or a strip as the data storage space.

It should be noted that, the present invention is suitable for any level of disk array with a fault-tolerant mechanism or without a fault-tolerant mechanism, e.g. Raid0, Raid1, Raid3, Raid5, Raid6, Raid10, Raid01 and Raid50 levels.

The present invention may be implemented by a computer program product, which can be borne in multiple storage media and includes some instructions, so as to enable a hardware platform, e.g. the above-mentioned disk array controller, to implement the above method. From an aspect of apparatus, an apparatus based on the present invention may include the above computer program product and a hardware platform operating the computer program.

Specifically, the present invention discloses a computer program, which includes the following steps when running: setting a master data storage space in a disk array, and accessing a strip contained in the master data storage space when a track in which the master data storage space is located is normal; setting at least one backup data storage space, and determining a first master data storage space in a damaged track when detecting that part of tracks of the disk in the disk array is damaged; selecting an idle first backup data storage space, and establishing a corresponding relation between an address of a strip contained in the first master data storage space and an address of a strip contained in the first backup data storage space; and receiving an instruction for accessing the strip contained in the first master data storage space, finding the strip contained in the first backup data storage space according to an address of the strip in the instruction and the corresponding relation, and accessing the strip contained in the first backup data storage space.

When the computer program is running, it further includes: constructing the disk array according to the size of required storage space of the disk array and the size of the preset backup data storage space, wherein the setting at least one backup data storage space includes: setting at least one backup data storage space in the disk array; or
the method further includes: constructing the disk array according to the size of required storage space of the disk array, wherein the setting at least one backup data storage space includes: demarcating a disk space shared by multiple disk arrays including this disk array and setting at least one backup data storage space in the shared disk space.

When the disk array has a fault-tolerant mechanism, when the program is running, it further includes:
after selecting the idle first backup data storage space and before receiving the instruction for accessing the strip contained in the first master data storage space, reconstructing data in the strip contained in the first master data storage space into the strip contained in the first backup data storage space.

If the address of the strip in the instruction is a logical address of the strip,
the establishing the corresponding relation includes: establishing a logical address of the strip contained in the first master data storage space and a physical address of the strip contained in the first backup data storage space.

If the address of the strip in the instruction is a logical address of the strip,
the establishing the corresponding relation includes: establishing a physical address of the strip contained in the first master data storage space and a physical address of the strip contained in the first backup data storage space; and
the finding the strip contained in the first backup data storage space includes: converting the logical address of the strip in the instruction into the physical address of the strip, and finding the strip contained in the first backup data storage space according to the converted physical address of the strip and the corresponding relation.

When the computer program is miming, it further includes:
when a track in which the first backup data storage space is located is damaged, selecting an idle second backup data storage space, updating the corresponding relation into a corresponding relation between the address of the strip contained in the first master data storage space and an address of a strip contained in the second backup data storage space, and if the disk array has a fault-tolerant mechanism, reconstructing data in the strip contained in the first master data storage space into the strip contained in the second backup data storage space;
receiving an instruction for accessing the strip contained in the first master data storage space, finding the strip contained in the second backup data storage space according to the address of the strip in the instruction and the updated corresponding relation, and accessing the strip contained in the second backup data storage space.

The data storage space is a stripe or a strip.

The foregoing descriptions are only preferred embodiments of the present invention and are not for use in limiting the protection scope thereof. Any modification, equivalent replacement and improvement made under the spirit and principle of the present invention should be included in the protection scope thereof.

What is claimed is:

1. A method for improving disk availability, comprising:
accessing a strip contained in a master data storage space set in a disk array when a track in which the master data storage space is located is normal;
determining, when detecting that part of tracks of a disk in the disk array is damaged, a first master data storage space in a damaged track;
selecting an idle first backup data storage space from at least one backup data storage space, establishing a corresponding relation between an address of a strip contained in the first master data storage space and an address of a strip contained in the first backup data storage space; and
receiving an instruction for accessing the strip contained in the first master data storage space, finding the strip contained in the first backup data storage space according to an address of the strip in the instruction and the corresponding relation, and accessing the strip contained in the first backup data storage space.

2. The method of claim 1, further comprising:
constructing the disk array according to the size of required storage space of the disk array and the size of the backup data storage space preset, wherein the at least one backup data storage space is set in the disk array.

3. The method of claim 1, wherein the disk array has a fault-tolerant mechanism and the method further comprises:
after selecting the idle first backup data storage space and before receiving the instruction for accessing the strip contained in the first master data storage space, reconstructing data in the strip contained in the first master data storage space into the strip contained in the first backup data storage space.

4. The method of claim 1, wherein the address of the strip in the instruction is a logical address of the strip; and
the establishing the corresponding relation comprises: establishing the corresponding relation between a logical address of the strip contained in the first master data storage space and a physical address of the strip contained in the first backup data storage space.

5. The method of claim 1, wherein the address of the strip in the instruction is a logical address of the strip; and
the establishing the corresponding relation comprises: establishing the corresponding relation between a physical address of the strip contained in the first master data storage space and a physical address of the strip contained in the first backup data storage space; and
the finding the strip contained in the first backup data storage space comprises: converting the logical address of the strip in the instruction into a physical address of the strip, and finding the strip contained in the first backup data storage space according to the converted physical address of the strip and the corresponding relation.

6. The method of claim 1, further comprising:
when a track in which the first backup data storage space is located is damaged, selecting an idle second backup data storage space, updating the corresponding relation into a corresponding relation between the address of the strip contained in the first master data storage space and an address of a strip contained in the second backup data storage space, and when the disk array has a fault-tolerant mechanism, reconstructing data in the strip contained in the first master data storage space into the strip contained in the second backup data storage space;
receiving the instruction for accessing the strip contained in the first master data storage space, finding the strip contained in the second backup data storage space according to the address of the strip in the instruction and the updated corresponding relation, and accessing the strip contained in the second backup data storage space.

7. The method of claim 1, wherein the data storage space is a stripe or a strip.

8. The method of claim 1, further comprising: constructing the disk array according to the size of required storage space of the disk array, wherein the at least one backup data storage space is set a disk space shared by multiple disk arrays including the disk array.

9. A disk array controller, comprising:
a disk space setting module, adapted to set at least one backup data storage space and set a master data storage space in a disk array;
an abnormity processing module, adapted to determine, when detecting that part of tracks of a disk in the disk array is damaged, a first master data storage space located in a damaged track, select an idle first backup data storage space, and store a corresponding relation between an address of a strip contained in the first master data storage space and an address of a strip contained in the first backup data storage space; and
an access processing module, adapted to find, when receiving an instruction for accessing the strip contained in the first master data storage space, the strip contained in the first backup data storage space according to an address of the strip in the instruction and the corresponding relation; and access the strip contained in the first backup data storage space.

10. The disk array controller of claim 9, wherein the disk space setting module is further adapted to construct the disk array according to the size of required storage space of the disk array and the size of the backup data storage space preset, and perform the setting the at least one backup data storage space in the disk array.

11. The disk array controller of claim 9, wherein the disk array has a fault-tolerant mechanism, and
the abnormity processing module is further adapted to reconstruct data in the strip contained in the first master data storage space into the strip contained in the first backup data storage space.

12. The disk array controller of claim 9, wherein the abnormity processing module is further adapted to select, when a track in which the first backup data storage space is located is damaged, an idle second backup data storage space; update the corresponding relation stored previously into a corresponding relation between the address of the strip contained in the first master data storage space and an address of a strip contained in the second backup data storage space; and if the disk array has a fault-tolerant mechanism, reconstruct data in the strip contained in the first master data storage space into the strip contained in the second backup data storage space;
the access processing module is further adapted to receive the instruction for accessing the strip contained in the first master data storage space, find the strip contained in the second backup data storage space according to the address of the strip in the instruction and the updated corresponding relation, and access the strip contained in the second backup data storage space.

13. The disk array controller of claim 9, wherein the disk space setting module is adapted to perform the setting through taking a stripe or a strip as the data storage space.

14. The disk array controller of claim 9, wherein the disk space setting module is further adapted to construct the disk array according to the size of required storage space of the disk array, demarcate a disk space shared by multiple disk arrays including the disk array, and perform the setting the at least one backup data storage space in the shared disk space.

15. A method for enhancing availability of a Redundant Array of Independent Disks (RAID), wherein the RAID is constructed with N disks comprising a plurality of strips, in which a plurality of stripes are constructed and each stripe comprises N strips respectively from N disks, wherein at least one strip acts as a parity strip in a stripe, the method comprising:
calculating the data in a master strip which belongs to a stripe according to the left strips in the stripe in response to a failure event of the master strip;
writing the calculated data into a backup strip which is located in the same disk for replacing the master strip;
mapping a logical address included in an access instruction of a host into a physical address of a backup strip after the writing.

16. The method of claim 15, further comprising: copying data in the left strips of the stripe into other backup strips, and mapping logical addresses included in access requests of the host into physical addresses of the other backup strips; wherein all the backup strips belong to a new stripe for replacing the stripe and provide continued service for the host.
